(19) United States
(12) Patent Application Publication
(10) Pub. No.: US 2017/0156351 A1
(43) Pub. Date: Jun. 8, 2017

(54) CARCASS DISPOSAL SYSTEM

(71) Applicant: KOREA ADVANCED INSTITUTE OF SCIENCE AND TECHNOLOGY, Daejeon (KR)

(72) Inventors: Hyeon-jeong SUK, Daejeon (KR); Gou Young KOH, Daejeon (KR); Jaemyung LEE, Daejeon (KR); Kyeong Ah JEONG, Daejeon (KR); Hyunjoo BAE, Daejeon (KR); Sung Yong CHOI, Daejeon (KR)

(73) Assignee: KOREA ADVANCED INSTITUTE OF SCIENCE AND TECHNOLOGY, Daejeon (KR)

(21) Appl. No.: 15/325,284

(22) PCT Filed: Jul. 11, 2015
(86) PCT No.: PCT/IB2015/055245

§ 371 Date: Jan. 10, 2017

Related U.S. Application Data
(60) Provisional application No. 62/023,637, filed on Jul. 11, 2014.

(51) Int. Cl. A22B 7/00; B65D 65/02; B65D 5/42; B65D 77/02; B65D 81/26; B65B 51/06; B65D 5/04; B65D 75/14; B65B 11/00; B65D 5/60

(52) U.S. Cl. CPC A22B 7/008; B65B 11/004; B65D 65/02; B65D 5/4266; B65D 5/60; B65D 81/264; B65B 51/06; B65D 5/04; B65D 75/14; B65D 77/02

(57) ABSTRACT

The present application describes a device that includes a packaging made of foldable stiff material, which is fastened to a fold-out drape.

### BACKGROUND OF THE INVENTION

1. Field of the Invention

The present application relates to a carcass disposal system and a method of disposing of the carcass.

2. General Background and State of the Art

Thus far in the field of disposal of small carcasses and in particular, in the disposal of small animals such as mice, rats, hamster, guinea pig, rabbit, small pig, frogs, fish, and so forth in particular in laboratory settings, there has been no “designed” system of comfortably, easily, effectively, hygienically, respectfully, and ethically disposing of these small dead animals. Rather, experimented-on animals were disposed of on an ad hoc basis, such as by wrapping them in paper towel or foil and incinerating them. There is a need in the art for an organized systematic system and device to dispose of small carcasses.

### SUMMARY OF THE INVENTION

In one aspect, the present inventive device is used to easily, effectively, respectfully, hygienically, and ethically remove and dispose of small dead and, in particular, experimental animals. This is achieved by simply pulling out a fold-out drape from a packaging made of foldable stiff material on to a working surface such as a table or floor, placing the dead animal on the drape, wrapping the animal with the drape and rolling the drape back to the packaging, wherein the packaging envelopes the carcass and the packaging is closed and locked such as by tape, thereby the packaging acting as a “casket” of sorts for these animals. The casket containing the dead animal may be frozen, incinerated, burned, buried, and so forth.

In a more detailed aspect, the present inventive system integrates a step of placing a small live animal on the above-mentioned drape and carrying out a surgical maneuver on the animal which eventually results in death of the animal, cleaning the carcass on the drape, and disposing of the carcass by wrapping the animal in the drape and rolling the drape over the animal back to the packaging as discussed above.

An advantage of the inventive device is that the device may be used which involves only folding and inserting steps. No mechanical or electrical tool is necessary to practice the invention. In addition, by using the device of the present invention, the carcass may be protected from further damage caused by mishandling of the carcass. The environment is also protected from unnecessary pollution by non-use of certain chemicals, which would otherwise need to be used in the processing of carcasses under conventional methods of disposal.

In one aspect, the invention is directed to a device comprising a packaging made of foldable stiff material, which may be fastened to a fold-out drape.

In another aspect, the invention is directed to a method of disposing of a small carcass comprising:
i. pulling and stretching out on to a surface a fold-out drape enfolded inside a packaging made of foldable stiff board;
ii. placing a small living animal or a small carcass on the drape;
iii. in the case that a small living animal is placed on the drape, conducting an experiment on the animal so as to produce a carcass;
iv. wrapping the carcass in the drape and rolling the drape back toward the packaging so as to be placed inside the packaging;
v. encasing the draped carcass within the packaging;
vi. closing the packaging and optionally locking the packaging with a fastener; and
vii. disposing of the packaging.

In the device or method according to above, the foldable stiff material may be composed of at least two, preferably three or four crease lines. The crease lines may be placed in perpendicular orientation to the direction of pull out of the fold-out drape. Alternatively, the foldable stiff board may be rollable. The foldable stiff board may be made from plastic or paperboard. The foldable stiff board may be of a size that is suitable to fit a small carcass that is wrapped in the drape when the board is re-folded. The dimensions of the foldable stiff board may be about 12 cm by 10 cm to 32 cm by 15 cm. The fold-out drape may be material that is substantially absorbent and/or impervious to liquid. The fold-out drape may comprise a fastener at an edge. And the dimensions of the fold-out drape may be about 25 cm by 25 cm to 50 cm by 50 cm. However, it is to be understood that the size of the packaging and the drape need not be specifically limited to these dimensions so long as a small animal is able to be wrapped in the drape and stored in the packaging.

One particular benefit of the present invention is that it provides a tool for researchers of animal experiments to have respect for their experimental animals and related experimental procedures and to proceed with their research more efficiently. The present invention would be appealing also to workers in experimental animal housing, facility, and husbandry and disposal, and also to animal use protesters.

These and other objects of the invention will be more fully understood from the following description of the invention, the referenced drawings attached hereto and the claims appended hereto.

### BRIEF DESCRIPTION OF THE DRAWINGS

The present invention will become more fully understood from the detailed description given herein below, and the accompanying drawings which are given by way of illustration only, and thus are not limitative of the present invention, and wherein;

FIG. 1 shows top view of the inventive device.

FIG. 2 shows the opening procedure of the inventive device.

FIG. 3 shows the closing procedure of the inventive device.

### DETAILED DESCRIPTION OF THE PREFERRED EMBODIMENTS

In the present application, “a” and “an” are used to refer to both single and a plurality of objects.

As used herein, “carcass” refers to a dead animal. Preferably, the dead animal is a small animal such as about or less than the size of a human adult hand. Such animals may include without limitation, fish, reptiles, amphibians such as frogs, or such as mice or rats, hamster, guinea pig, rabbit, small pig, and so forth. In particular, “carcass” also refers to laboratory animals which have undergone experimentation such as genetic modifications. And it is especially desired to securely and respectfully dispose of such animals, given the potential dangers associated with genetically modified animals that have been intentionally infected with viruses and so forth.

As used herein, “packaging” and “container” are used interchangeably and refer to a substantially stiff foldable sheet of material, which in its closed form (pre-packaging form) is folded to provide housing for a fold-out drape packaged therein. In a preferred embodiment, the “packaging” or “container” containing the folded drape is set forth in a relatively flat form. As the packaging is opened and the drape is stretched or pulled out from the packaging, the packaging is seen as a single sheet of stiff board with multiple panels separated by several crease lines present between the panels.

The “packaging” or “container” material may be made as stiffly as desired depending on how the packaging is desired to be stored after the small carcass is encased in the packaging. For instance, the shape of the post-packaging form may be a triangular prism, which provides a certain advantage in stacking of the post-packaging form. However, other post-packaging shapes are possible such as a square cylinder, or even a circular cylinder. In the case that a circular cylinder is desired to be made, it is possible that packaging may not necessarily have crease lines and may not necessarily be as stiff as a packaging for which the post-packaging shape is a triangular cylinder (prism) or square cylinder.

As regards “stiffness” of the material of the packaging, the packaging may be made of any material that has some degree of stiffness. Paperboard is preferred. Other such material may include wood based material or plastic. Stiffness is defined as the material's resistance to bending caused by a given applied force. Stiffness itself also relates to other strength properties such as compression strength, toughness, creasability, foldability, and so forth. It is, however, in itself a very individual property which is easily measured. In certain embodiments, if the packaging is desired to be a rolled type of packaging such as a cylinder, then the stiffness of the packaging may be less than the stiffness of a packaging that is desired to be in a more rigid form, such as a triangular prism type post-packaging shape.

As used herein, in particular, “pre-packaging” form refers to the shape of the closed packaging that contains the pre-folded fold-out drape before the drape is pulled out of the packaging.

As used herein, in particular, “post-packaging” form refers to the shape of the packaging after the small carcass is draped and encased in the packaging and the packaging is closed.

The folding step is dependent on the creases because the folding of the stiff material occurs along the crease lines.

As for “creasing”, optimum creasing conditions such as thickness, width and depth of groove and so forth should be made to ensure consistent folding in the packaging. If the folding resistance is too high in relation to the stiffness of the material it can result in panel bowing. It is understood that different material board type requires its own settings to give the best result.

The packaging also includes features for closing and opening it, where required. Closure and reclosure features can be chosen from a number of design options. These features provide security and protection of the contents during storage and subsequent convenience for the user. An example is the tuck-end method, which is an efficient method of opening and reclosing. Gluing and taping may be other options.

The drape may be preferably surgical drape, which are absorbent and impervious to liquid if surgery is desired to be conducted on the drape before disposing of the carcass. However, if a carcass is simply desired to be disposed of without conducting any experimentation on the drape, the drape may be made of vinyl, plastic or paper, which is used to simply wrap a carcass and roll it into the container.

In one aspect, a one clasp or fastener such as tape is attached on an edge of the drape such that as the drape is unfolded from the packaging, the drape is secured to the working surface by the clasp attaching to the working surface.

The drape as depicted in the figures is square or rectangular shaped, however, the drape may be any shape at all, including circular, so long as the drape is able to be used to wrap a small dead animal in it and rolled into the packaging.

In one aspect, the fold-out drape may be unfolded while one edge is attached to the packaging. An animal experiment may be optionally conducted on the animal that is placed on the drape. After finishing the experimentation, the drape is folded over the carcass. The drape is rolled into the foldable stiff board. The foldable stiff board is folded around the carcass that is rolled in the drape. A fastener is used to hold the folded stiff board in place thereby closing the packaging.

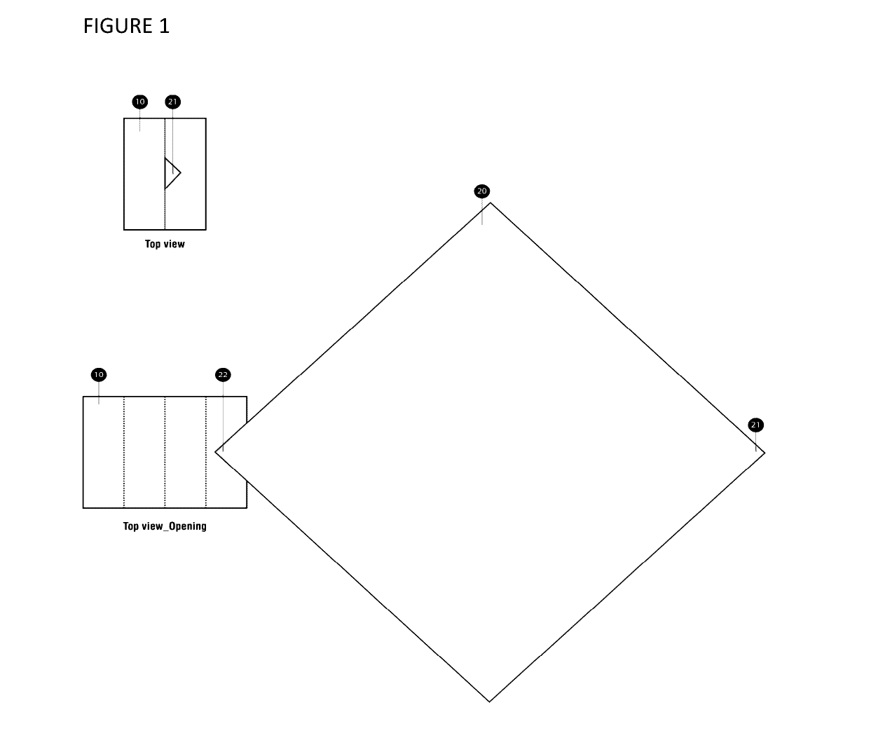

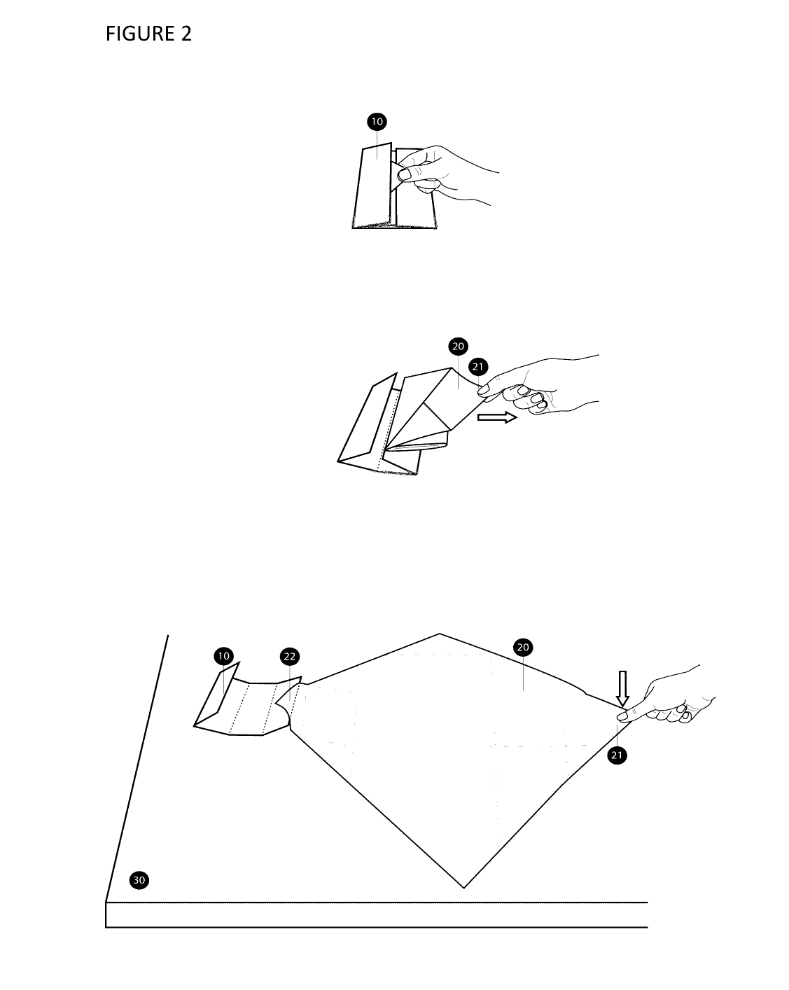

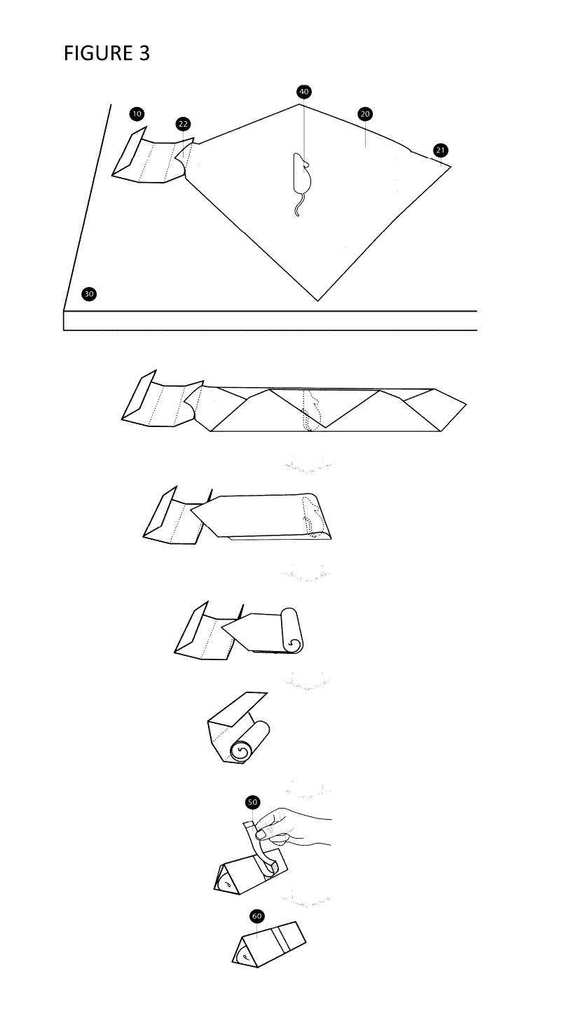

Turning to the figures, as the packaging (10) is initially opened, a folded fold-out drape (20) is pulled out and stretched out fully on to a work surface (30), while still attached to the packaging by attachment site (22). See FIGS. 1 and 2. On and edge of the fold-out drape is a fastener (21) such as a tape, which is used to securely attach the drape to the work surface (30). See FIG. 2. A small dead animal (40) is placed on the stretched out drape, and is wrapped in the drape and is rolled back to the packaging (10) so as to be encased in the packaging (10). See FIG. 3. The packaging (10) is closed and locked with a fastener (50) to form a post-packaging (60). See FIG. 3.

In an alternative embodiment, in FIG. 2, a live animal (40) is placed on the drape (30) and after a time on the drape, the animal is killed. The carcass is then wrapped in the drape and is rolled back to the packaging (10) so as to be encased in the packaging (10). See FIG. 3. The packaging (10) is closed and locked with a fastener (50) to form a post-packaging (60). See FIG. 3.

In one example, the following steps may be carried out to practice the invention.

1. From a packaging, a fold-out drape is unfolded and stretched or pulled out on to a work surface as the drape remains securely connected to the packaging.

2. As the drape is further stretched out on a work surface, optionally, an edge of the drape may include a clasp or a fastener that stably attaches to the work surface so as to provide a securely fixed drape on the work surface.

3. An animal may be experimented on directly on the drape on the work surface.

4. After conclusion of the experiment, the carcass may be wrapped in the drape.

5. The carcass wrapped in the drape may be wrapped and rolled toward and into the packaging.

6. The packaging may encase the carcass that is wrapped in the drape, and the packaging sealed with a fastener, preferably a pre-attached tape on the sheet of foldable material.

All of the references cited herein are incorporated by reference in their entirety.

Those skilled in the art will recognize, or be able to ascertain using no more than routine experimentation, many equivalents to the specific embodiments of the invention specifically described herein.

What is claimed is:

1. A device comprising a packaging made of foldable stiff material, which is fastened to a fold-out drape.

2. The device according to claim 1, wherein the foldable stiff material is composed of at least two crease lines.

3. The device according to claim 2, wherein the crease lines are placed in perpendicular orientation to the direction of pull out of the fold-out drape.

4. The device according to claim 1, wherein the foldable stiff board is rollable.

5. The device according to claim 1, wherein the foldable stiff board is made from plastic or paperboard.

6. The device according to claim 1, wherein the fold-out drape may be material that is substantially absorbent and/or impervious to liquid.

7. The device according to claim 1, wherein the foldable stiff board is of a size that is suitable to fit a small carcass that is wrapped in the drape when the board is folded.

8. The device according to claim 1, wherein the fold-out drape comprises a fastener at an edge.

9. The device according to claim 1, wherein the dimensions of the foldable stiff board is about 12 cm by 10 cm to 32 cm by 15 cm.

10. The device according to claim 1, wherein the dimensions of the fold-out drape is about 25 cm by 25 cm to 50 cm by 50 cm.

11. A method of disposing of a small carcass comprising:
i. pulling and stretching out on to a surface a fold-out drape enfolded inside a packaging made of foldable stiff board;
ii. placing a small living animal or a small carcass on the drape;
iii. in the case that a small living animal is placed on the drape, conducting an experiment on the animal so as to produce a carcass;
iv. wrapping the carcass in the drape and rolling the drape back toward the packaging so as to be placed inside the packaging;
v. encasing the draped carcass within the packaging;
vi. closing the packaging and optionally locking the packaging with a fastener; and
vii. disposing of the packaging.

12. The method according to claim 11, wherein the foldable stiff material is composed of at least two crease lines.

13. The method according to claim 12, wherein the crease lines are placed in perpendicular orientation to the direction of pull out of the fold-out drape.

14. The method according to claim 11, wherein the foldable stiff board is rollable.

15. The method according to claim 11, wherein the foldable stiff board is made from plastic or paperboard.

16. The method according to claim 11, wherein the fold-out drape may be material that is substantially absorbent and/or impervious to liquid.

17. The method according to claim 11, wherein the foldable stiff board is of a size that is suitable to fit a small carcass that is wrapped in the drape when the board is folded.

18. The method according to claim 11, wherein the fold-out drape comprises a fastener at an edge.

19. The method according to claim 11, wherein the dimensions of the foldable stiff board is about 12 cm by 10 cm to 32 cm by 15 cm.

20. The method according to claim 11, wherein the dimensions of the fold-out drape is about 25 cm by 25 cm to 50 cm by 50 cm.

21. The method according to claim 11, wherein the carcass is laboratory animal.
